(19) United States
(12) Patent Application Publication
(10) Pub. No.: US 2002/0151281 A1
(43) Pub. Date: Oct. 17, 2002

(54) Front end communications system using RF mem switches

(75) Inventors: Hossein Izadpanah, Thousand Oaks, CA (US); Robert R. S. Barnard, Long Beach, CA (US); Juan F. Lam, Agoura Hills, CA (US); Brett A. Warneke, Berkley, CA (US); Gary M. Lindgren, Oak Park, CA (US); Robert Y. Loo, Agoura Hills, CA (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(73) Assignee: Hughes Electronics Corporation

(21) Appl. No.: 10/160,986

(22) Filed: May 30, 2002

Related U.S. Application Data
(63) Continuation of application No. 09/372,823, filed on Aug. 12, 1999.

(51) Int. Cl. H04B 1/44

(52) U.S. Cl. 455/83; 455/78

(57) ABSTRACT

A front end module (10, 30) for a low weight, low power communications system. The front end module (10) utilizes RF microelectromechanical (MEM) switches (16, 18, 20, 110, 112, 156) for dynamic reconfiguration capability. Components (12, 14, 22, 24, 26, 28) are shared for both the transmit and receive modes, thereby reducing the number of components required by the system (10, 30).

### CROSS REFERENCE TO RELATED APPLICATIONS

This application is a continuation of pending prior application Ser. No. 09/372,823, filed Aug. 12, 1999. The present application is cross-referenced to U.S. Pat. No. 5,121,089 entitled “Micro-Machined Switch and Method of Fabrication” which is incorporated by reference herein.

### TECHNICAL FIELD

The present invention relates to a front end communications module. More particularly, the present invention relates to a lightweight, low power front end module for a communication system using RF micro-electromechanical (MEM) switches.

### BACKGROUND ART

Typical communication front end modules have two sets of components. One set for the receive path and another set for the transmit path. Semiconductor switches are used to activate and route a signal through to the appropriate path. The semiconductor switches are not always compatible with lightweight, low power front end module technologies because they utilize transistors such as Bipolar Junction Transistors (BJT's), Field Effect Transistors (FET's) and Heterostructure Bipolar Transistors (HBT's).

FIG. 1 is a diagram of a prior art, single frequency, personal communications system (PCS) 200 using a manufacturer specific chip set (ATT GSM for example) as an example. The figure is intended to illustrate the system's complexity due to the large number of components required for the transceiver and the dual transmit/receive signal paths. The number of components required increases for multiple frequency systems (not shown). The need for a large number of components translates into increased power consumption, increased design complexity, and increased weight of the system, all of which are undesirable in low weight, low power consumption applications such as Micro Air Vehicles (MAV's), disclosed in U.S. Pat. No. 5,121,089 which is incorporated by reference herein; personal portable communication systems (i.e., PCS and cellular phones), distributed sensor, and satellite networks.

### SUMMARY OF THE INVENTION

The present invention is a front end module for a low weight, low power communications system. The front end module utilizes RF MEM switches, instead of semiconductor switches, for dynamic reconfiguration capability and to enhance functionality of the front end module. The front end module of the present invention shares components between the transmit and receive operations, thereby reducing the number of components required by the system and resulting in a reduction in weight and power consumption. MEM switches are compatible with essentially any semiconductor process, allowing higher levels of integration than previously afforded using semiconductor switches that are not always compatible with lightweight, low power communication systems.

It is an object of the present invention to share components resulting in a lighter weight, low power front end module. It is another object of the present invention to simplify the communications system circuit design by reducing the number of components required by the system. It is yet another object of the present invention to provide a front end module that is capable of operating in Time Division Multiple Access (TDMA) mode.

Other objects and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a block diagram of a prior art PCS transceiver module for a communications system;

FIG. 2 is a block diagram of the front end module of the present invention;

FIG. 3 is a table comparing the power dissipation of a prior art front end module and the front end module of the present invention;

FIG. 4 is a block diagram of the front end module of the present invention incorporating an additional power amplifier for high power and low input applications;

FIG. 5 is a perspective, cut-away view of a dual frequency aperture coupled dipole antenna;

FIG. 6 is a plan-view schematic of a reconfigurable filter; and

FIG. 7 is a block diagram of another embodiment of the front end module of the present invention having selectable antenna and a reconfigurable filter.

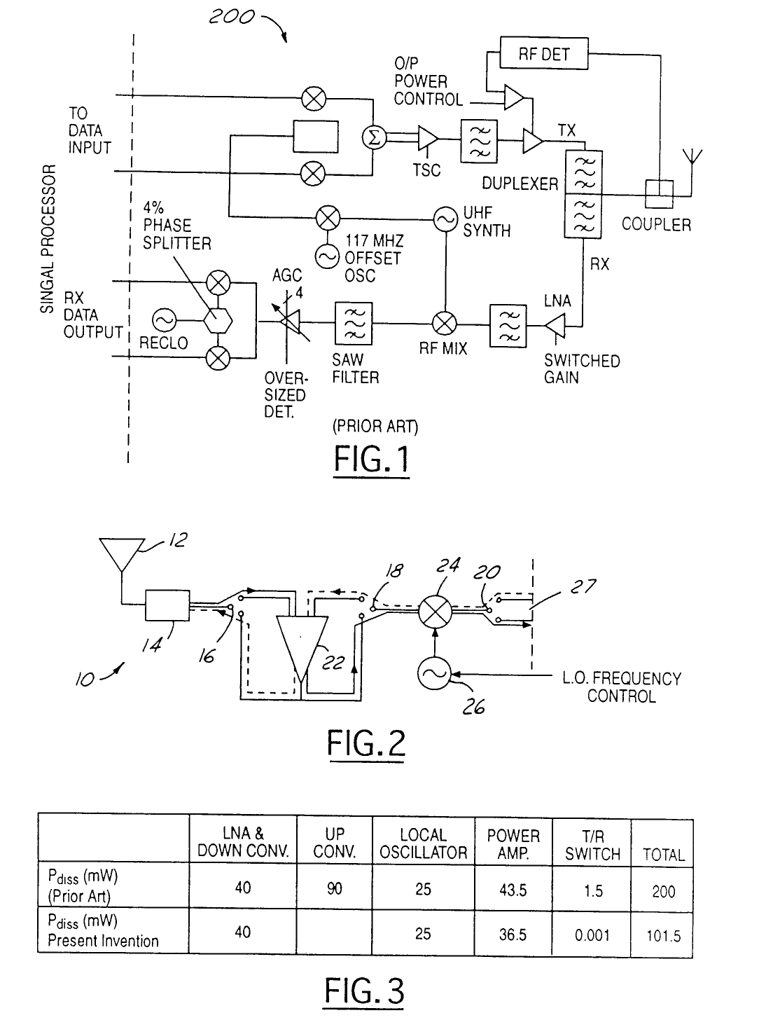

### BEST MODE(S) FOR CARRYING OUT THE INVENTION

A front end module 10 of the present invention is shown in FIG. 2. A single antenna 12 and a single pre-selector filter 14 are common to both the transmit and receive paths. A set of three MEM switches 16, 18 and 20 is used to share the functionality of one amplifier 22, one mixer 24 and one local oscillator 26 between the transmit and receive paths.

In the receive mode, a signal, shown by a solid line path in FIG. 2, will pass from the pre-selector filter 14 to the amplifier 22 and through the mixer 24 for conversion where it passes through MEM switch 20 to a PCS chip set receiving terminal 27 where signal processing is performed. In the transmit mode, the MEM switches reverse the mixer and amplifier connection such that a transmitted signal, shown by a dashed line path in FIG. 2, reaches the pre-selector filter 14 and the antenna 12 for transmission.

In comparison to the prior art front end module, the front end module 10 of the present invention shares the RF/Microwave down/up conversion electronics and component functionality thereby simplifying the circuit, reducing weight and lowering power consumption. Only one filter 14, amplifier 22, mixer 24 and local oscillator 26 are used in the TDMA system.

A TDMA system is a system in which the transmit (receive) mode is idle while the receive (transmit) mode is in operation. The RF MEM switches 16, 18 and 20 are configured to open and close the desired signal path for either mode. For example, the configuration of the switches completes one path and opens another. So for example, in the receive mode a signal is allowed to pass, while the path for the transmit mode is incomplete and a signal cannot pass. The signal paths are reverse for the transmit mode. The transmit path is complete and the receive path is incomplete, merely by switching on the part of the RF MEM switches 16, 18 and 20.

Frequency control for local oscillator 26 can be provided as shown in FIG. 2. The frequency at the local oscillator can be used to introduce a shift in frequency that will change the receive frequency relative to the transmit frequency.

FIG. 3 illustrates the differences in power consumption between a prior art front end module 100 and the front end module 10 of the present invention operating at a frequency of 2.4 GHz. The MEM switches used in the front end module 10 of the present invention exhibit nearly ideal switching behavior, therefore their insertion loss is very low. The total power dissipated by the front end module of the present invention is significantly lower (by approximately one-half) than the power dissipated by prior art front end modules.

The lower power dissipation of the present invention is due to the fact that there are less components. So not only do fewer components reduce the weight of the front end module, but also the power consumption is reduced and the Transmit/Receive isolation is increased, thereby improving the overall module reliability. The use of RF MEM switches, that are compatible with any semiconductor process, allows the same components to be used to perform both the transmit and receive functions. Also, there is no need for additional “power down” components, that are present in the prior art, for powering off the set of transmit (receive) components while the receive (transmit) components are in operation. The RF MEM switches have a very low insertion loss, and therefore, even though the present invention has more switches than prior art front end modules, it has fewer overall components and is much more power efficient than prior art front end modules.

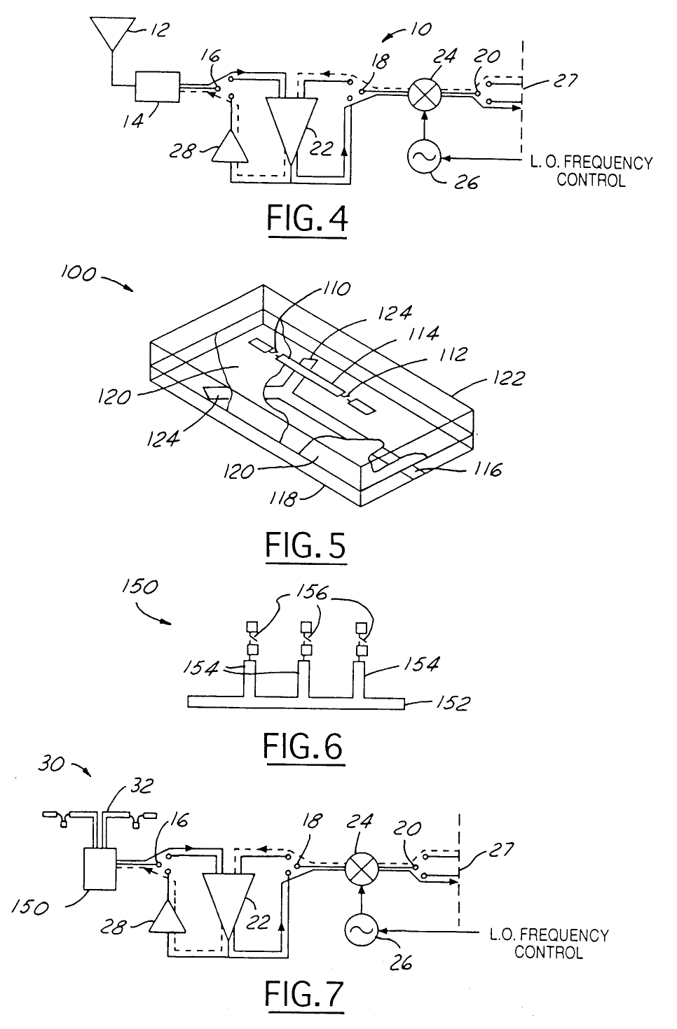

It is possible to increase the operating range of the front end module of the present invention to include higher power transmitter and low input applications. An additional amplifier 28 having sufficient gain and output power can be added to the signal transmit path, as shown in FIG. 4.

Single frequency operation has been described herein. However, it is possible to apply the present invention to multiple frequency applications. In such cases it is possible to use a reconfigurable antenna and pre-selector filter in order to change transmit and receive frequency differences. The reconfigurable antenna and pre-selector filter can be accomplished by applying RF MEM switches to select from multiple frequencies.

A reconfigurable antenna 100 is shown in FIG. 5. For example purposes, a dual frequency aperture-coupled dipole antenna is shown. However, it is possible to extend the operation to additional frequencies. The use of MEM switches allows the transmission and reception at two widely spaced frequencies and also provides isolation between frequency bands.

The primary radiating element is a printed dipole antenna 114 whose frequency band of efficient radiation is determined by the dipole length. Two MEM switches 110, 112 are located along the segmented dipole for adjusting length of the dipole 114. To select a frequency band, the switches 110 and 112 are either turned on or off, adjusting the length of the dipole 114 thereby selecting between two frequencies. For example, MEM switches 110 and 112 are turned “on” for a lower frequency band, and the switches 110 and 112 are turned “off” for an upper frequency band.

The dipole 114 is fed by a microstrip transmission line 116 located on one substrate board 118. A ground plane 120 is sandwiched between substrate board 118 and another substrate board 122. The microstrip transmission line 116 has a quarter wavelength stub 124 for each frequency. Thus the antenna's operation can be extended to other frequencies merely by adding more stubs in the feedline and more switches in the dipole.

FIG. 6 is plan-view schematic of a reconfigurable filter 150. A microstrip transmission line 152 has open stubs 154 that provide a frequency dependent impedence in parallel with the distributed impedance of the microstrip transmission line 152. MEM switches 156 are used to alternately connect and disconnect the stubs 154, thereby affecting the frequency response of the filter 150. Such an extensive use of switches is possible because of the low insertion loss, high isolation, low cost, low power dissipation, and simple actuation technique associated with MEM switches.

FIG. 7 is a block diagram of a front end module 30 of the present invention for a multiple frequency application. Like reference numbers in FIG. 7 describe like components as described by the same reference number in FIG. 2. Referring to FIG. 7, Antenna 32 and bandpass filter 34 are reconfigurable. In the present example, one filter 34 is shown but it is also possible to have more than one bandpass filter and an MEM switch selectable among the plurality of filters (not shown). In either case, it is possible to reconfigure the front end module for a desired frequency.

While particular embodiments of the invention have been shown and described, numerous variations and alternate embodiments will occur to those skilled in the art. Accordingly, it is intended that the invention be limited only in terms of the appended claims.

What is claimed is:

1. A front end module comprising:
an antenna;
a filter connected to said antenna;
a first microelectromechanical switch connected to said filter and switchable between a first path and a second path;
an amplifier common to both first and second paths;
a second microelectromechanical switch switchable between said first and second paths and connected to said amplifier;
a mixer connected to said second microelectromechanical switch;
a local oscillator connected to said mixer; and
a third microelectromechanical switch following said mixer and switchable between said first and second paths;
whereby said first, second and third microelectromechanical switches are switchable between said first and second paths for selecting a transmit and a receive mode for said front end module.

2. The front end module as claimed in claim 1 wherein one of said first and second paths has an additional amplifier.

3. The front end module as claimed in claim 1 wherein said antenna further comprises a reconfigurable antenna and said filter further comprises a reconfigurable filter.

4. The front end module as claimed in claim 3 wherein said reconfigurable antenna and said reconfigurable filter further comprise microelectromechanical switches for selecting one of a plurality of frequencies.

5. A front end module comprising:
an antenna;
a filter connected to said antenna;
a first low power microelectromechanical switch having high isolation, said first microelectromechanical switch being connected to said filter and switchable between a first path and a second path;
an amplifier common to both first and second paths;
a second low power microelectromechanical switch having high isolation, said second microelectromechanical switch being switchable between said first and second paths and connected to said amplifier;
a mixer connected to said second microelectromechanical switch;
a local oscillator connected to said mixer; and
a third low power microelectromechanical switch having high isolation, said third microelectromechanical switch following said mixer and being switchable between said first and second paths;
whereby said first, second and third microelectromechanical switches are switchable between said first and second paths for selecting a transmit and a receive mode for said front end module.

6. The front end module as claimed in claim 5 wherein one of said first and second paths has an additional amplifier.

7. The front end module as claimed in claim 1 wherein said antenna further comprises a reconfigurable antenna and said filter further comprises a reconfigurable filter.

8. The front end module as claimed in claim 3 wherein said reconfigurable antenna and said reconfigurable filter further comprise microelectromechanical switches for selecting one of a plurality of frequencies.
